(19) United States
(12) Patent Application Publication
(10) Pub. No.: US 2012/0195425 A1
(43) Pub. Date: Aug. 2, 2012

(54) SECURITY VIDEO TRANSMISSION APPARATUS, VIDEO DATA RECEPTION APPARATUS, AND KEY GENERATION METHOD THEREOF

(75) Inventors: Young Sae KIM, Daejeon (KR); Yong-Sung Jeon, Daejeon (KR); Moo Seop Kim, Daejeon (KR); Jong-Wook Han, Daejeon (KR); Geonwoo Kim, Daejeon (KR); Jin Hee Han, Daejeon (KR); Hong Il Ju, Daejeon (KR); SuGil Choi, Daejeon (KR); Min-ho Han, Daejeon (KR); Su Wan Park, Daejeon (KR)

(73) Assignee: Electronics and Telecommunications Research Institute, Daejeon (KR)

(21) Appl. No.: 13/331,280

(22) Filed: Dec. 20, 2011

(30) Foreign Application Priority Data
Dec. 23, 2010 (KR) 10-2010-0133148

(51) Int. Cl. H04L 9/00

(52) U.S. Cl. 380/200

(57) ABSTRACT

There is provided a security video transmission apparatus for generating and updating an encryption key by using video data, having a property of a random number which is continuously generated in real time, as random number data in order to generate a key, encrypting the video data using the encryption key, and then transmitting the encrypted video data.

### CROSS-REFERENCE TO RELATED APPLICATION(S)

The present invention claims priority of Korean Patent Application No. 10-2010-0133148, filed on Dec. 23, 2010, which is incorporated herein by reference.

### FIELD OF THE INVENTION

The present invention relates to a security video transmission apparatus, an video data reception apparatus, and a key generation method; and, in particular, to a security video transmission apparatus and an video data reception apparatus which are included in a security video system, and an encryption or decryption key generation method using them.

### BACKGROUND OF THE INVENTION

Generally, security video systems using security video transmission apparatuses, such as cameras called Closed-Circuit Televisions (CCTVs), have already been selected for a surveillance and security method in various types of fields. Recently, there is a trend to change to using high performance digital network cameras including an video compression technique from the existing analog type surveillance cameras. Here, so-called intelligent camera including video recognition and encryption technology is rising as a next generation technology, and the technical development related thereto has currently been a big issue in the relevant market. In the case of a security video system which controls a security video camera having an encryption function, video data transmitted from the camera is encrypted, so that video obtainment apparatuses, such as an video surveillance apparatus and an video storage apparatus, which access the camera may check original videos by performing a decryption function using a key which is identical to that of the camera. Otherwise, since the videos are encrypted, videos cannot be identified.

However, generally a method of encrypting video data is used on most of the interesting sections of the security video system using a security video camera. However, when viewed from in light of an actual security video system operation, in addition to the encryption method, a method capable of periodically generating a key and managing it in order to enforce security is also very important. If the same encryption key is continuously used only for the purpose of easy realization, there is security vulnerability because a key may be exposed. Meanwhile, if a key generation method or a separate key distribution protocol, which is additionally complicated, is used, there is a problem of inefficiency from the point of view of the security video camera which has restricted resources and from the point of view of the security video system which integrally manages a plurality of cameras.

### SUMMARY OF THE INVENTION

In view of the above, the present invention provides a security video transmission apparatus, an video data reception apparatus, and a key generation method, which are capable of simplifying the process of generating and updating an encryption key in such a way as to use video data, which is the main output of a security video transmission apparatus, such as a camera, as an input value having the property of a random number used to generate a key, and sharing a key between the security video transmission apparatus and an video data reception apparatus which accesses the security video transmission apparatus without performing a separate key transmission process.

In accordance with a first aspect of the present invention, there is provided a security video transmission apparatus for generating and updating an encryption key by using video data, having a property of a random number which is continuously generated in real time, as random number data in order to generate a key, encrypting the video data using the encryption key, and then transmitting the encrypted video data.

In accordance with a second aspect of the present invention, there is provided a security video transmission apparatus, including: an video collection unit for collecting videos and turning the collected videos into information; an video processing unit for encoding the collected videos, and generating compressed video data which may be easily transmitted; a key management unit for generating an encryption key by using the video data, having a property of a random number which is continuously generated in real time, as random number data used to generate the key; an video data encryption unit for encrypting the video data using the encryption key; and an video data transmission unit for transmitting the encrypted video data to a network.

In accordance with a third aspect of the present invention, there is provided an encryption key generation method using a security video transmission apparatus, including: generating an encryption key by using video data, having a property of a random number which is continuously generated in real time, as random number data used to generate a key; and updating the generated the encryption key to a new encryption key by combining the generated encryption key with a previous encryption key.

In accordance with a fourth aspect of the present invention, there is provided a decryption key generation method using an video data reception apparatus, comprising receiving video data while usually accessing a security video transmission apparatus; and generating and updating a decryption key, which is identical to an encryption key of the security video transmission apparatus, using original video data obtained by decrypting the received and encrypted video data, thereby sharing a key with the security video transmission apparatus without performing a separate key transmission process.

In accordance with the embodiment of the present invention, video data generated by the security video transmission apparatus has a property of a random number which is continuously generated in real time. Therefore, the video data itself can be used as a single random number, so that the security video transmission apparatus may further effectively generate and update a key using the video data, and an apparatus for accessing the security video transmission apparatus and receiving the video data may share the key with the security video transmission apparatus by generating and updating a key, which is the same as the encryption key which was used by the security video transmission apparatus, using only the received video data without performing a separate key transmission process.

Therefore, the security video transmission apparatus side does not require a separate random number generator in order to generate a key, so that there is the advantage of simplifying a key generation procedure. Further, any additional communication procedure for transmitting a key in order to share the key with a reception apparatus is not required, so that there is the advantage in that a plurality of security video transmission apparatuses may be easily managed. Furthermore, the updated key itself continuously stores the hash information of video data, so that the same key can be generated between the transmission and reception apparatuses. The integrity of the video data may be checked merely by performing encryption and decryption using the key as normal, so that there is the advantage of being able to manage an attack that forges and falsifies video data.

### BRIEF DESCRIPTION OF THE DRAWINGS

The objects and features of the present invention will become apparent from the following description of d embodiments given in conjunction with the accompanying drawings, in which:

FIG. 1 is a diagram illustrating the configuration of a security video system in accordance with an embodiment of the present invention;

FIG. 2 is a block diagram illustrating the detailed configuration of a camera in accordance with an embodiment of the present invention;

FIG. 3 is a flow chart illustrating a method of generating and updating a key using the camera in accordance with an embodiment of the present invention;

FIG. 4 is a flow chart illustrating a method of generating and updating a key using a first video data reception apparatus in accordance with an embodiment of the present invention; and

FIG. 5 is a flow chart illustrating a method of generating and updating a key using a second video data reception apparatus in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

The “camera” described throughout the specification may indicate a security video transmission apparatus, such as an video secure network camera, which includes video compression and encryption functions and which is capable of transmitting videos in real time. Further, the “first video data reception apparatus” may be an apparatus, such as a Network Video Recorder (NVR) which is an video data storage apparatus, which continuously receives video data for the purpose of storing video data while the apparatus is connected to a security video camera. Further, the “second video data reception apparatus” may be an apparatus, such as a control apparatus, that is, an video data surveillance apparatus, which accesses a camera at an arbitrary time point and obtains video data for an arbitrary time period for the purpose of checking and monitoring the videos of the camera.

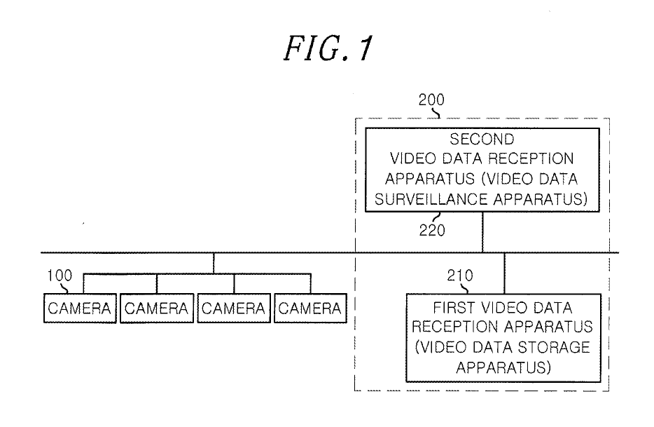

FIG. 1 is a diagram illustrating the configuration of a security video system in accordance with an embodiment of the present invention.

As shown in the drawing, the security video system may include a plurality of cameras 100 and an video data reception apparatus 200. The video data reception apparatus 200 may include a first video data reception apparatus 210 and a second video data reception apparatus 220.

Each of the cameras 100 functions as a security video camera, and performs the functions of collecting and processing videos in real time, and then encrypting the videos and transmitting the resulting videos.

The video data reception apparatus 200 is an apparatus for accessing the plurality of cameras 100 on a network, and receiving video data transmitted from the cameras 100.

The first video data reception apparatus 210 is an apparatus for always accessing the cameras 100 and continuously receiving video data in real time. The first video data reception apparatus may be implemented using an video data storage apparatus, such as NVR, which usually stores video data in order to use the video data as evidentiary data.

The second video data reception apparatus 220 is an apparatus for accessing the cameras 100 if necessary and continuously receiving video data for an arbitrary time period in real time after access has been made. The second video data reception apparatus 220 may be implemented as an video data monitoring apparatus such as a control apparatus.

Depending on the method of operating the system, the second video data reception apparatus 220 may fetch and then check video data stored in the first video data reception apparatus 210, and the first video data reception apparatus 210 and the second video data reception apparatus 220 may be integrated into a single apparatus.

In the embodiment of the present invention, a key can be effectively generated and updated in such a way as to generate and update a key using randomness which is a property of the video data, and to share the same encryption key between the cameras 100 and the video data reception apparatus 200 without having to perform a separate key exchange procedure.

Generally, a method of sharing the same key between security communication systems on a network includes a method of sharing the same key in such a way as to generate a key at one side and then transmit the key to the other side, and a method of sharing the same key in such a way as to exchange a specific value in order to share a key between both sides and then to generate a key using the same key generation method. Here, it is required to generate a random number as an input value used to generate a key.

Meanwhile, in the case of the security video system in accordance with the embodiment of the present invention, video information, input to a camera, has the property of random number which is continuously generated in real time, so that the video information itself may be used as a single random number. Therefore, the camera may effectively generate and update a key using video data, and the video data reception apparatus may generate and update a key which is the same as an encryption key used by the camera, that is, a decryption key, using the received video data without having to perform a separate key transmission process. Furthermore, the hash information of the video data may be continuously accumulated in the updated key itself, so that the same key may be generated between the camera and the video data reception apparatus. The integrity of video data can be determined only by normally performing encryption and decryption using the key, thereby managing an attack of forging and falsifying video data.

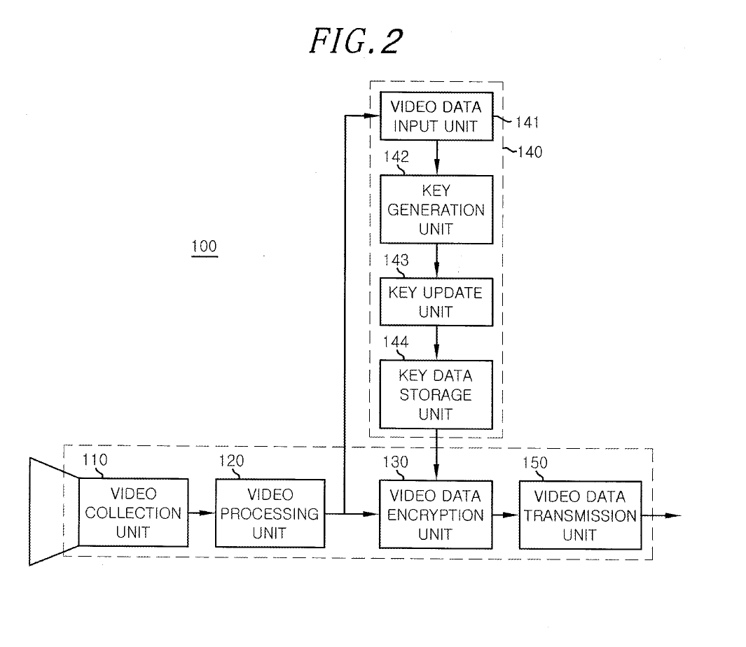

FIG. 2 is a block diagram illustrating the detailed configuration of the camera in accordance with an embodiment of the present invention.

Referring to FIG. 2, the camera 100 may include an video collection unit 110, an video processing unit 120, an video data encryption unit 130, a key management unit 140, and an video data transmission unit 150. The key management unit 140 may include an video data input unit 141, a key generation unit 142, a key update unit 143, and a key data storage unit 144.

The elements of the camera 100 of FIG. 2 indicate only the simplified elements which are necessary to acquire and transmit videos and to generate and update an encryption key in accordance with the embodiment of the present invention, and various peripheral elements which are necessary to configure the camera may be further included.

The video collection unit 110 collects physical videos which are input to the camera 100 and turns them into information. The video processing unit 120 encodes information about the collected videos using a codec, thereby generating compressed video data which can be easily transmitted.

The video data encryption unit 130 is the section of the camera which is most clearly distinguished from a general camera. The video data encryption unit 130 encrypts video data using an encryption algorithm in order to protect the video data. For example, a symmetric algorithm in which an encryption key is identical to a decryption key may be used as a data encryption algorithm.

The encrypted video data is transmitted to a network using the video data transmission unit 150 such that video data reception apparatuses which accessed the camera via a network may receive the video data in real time.

The key management unit 140 enables the encryption function to be more safely performed. The key management unit 140 may include an video data input unit 141 which receives the video data, generated by the video processing unit 120, as new random number data used to generate a key, in order to generate and update a key, a key generation unit 142 which generates a key using the random number data at a previously scheduled key generation time point, a key update unit 143 which generates a new encryption key by combining the generated key with a previous encryption key, and a key data storage unit 144 which stores a master key that will be used in a hash function used to generate a key, a master encryption key that will be used for the initial encryption and an encryption key that is currently being used, and key generation-related information including the time of key generation.

With regard to the process of generating and updating a key in accordance with the embodiment of the present invention using the operations of the respective elements, first, the video data input unit 141 has the effect of generating a random number only when simply receiving video data which has a property of a random number, so that a random number generator, which is necessary in the key generation methods normally used, is not required.

Next, the key generation unit 142 performs the function of generating a new key having a key length which is required when the received video data is encrypted. This function can be processed using, for example, a hash method, and various methods which can generate a desired form of output may be additionally applied.

The key update unit 143 performs the function of updating to a new encryption key by combining an encryption key which is currently being used with the key generated by the key generation unit 142. This function may be processed using a data combination method such as an exclusive OR operation, and various methods which can generate a desired form of output may be additionally applied.

The updated key is stored in the key data storage unit 144, and used in the process of encrypting subsequent video data. The key data storage unit 144 stores an encryption key that is currently being used, other keys, and key-related data. The key data storage unit 144 stores a master key used in the hash method performed by the key generation unit 142, a master encryption key used to perform an initial encryption function, and other data, such as key generation-related information which enables a key to be generated by designating an arbitrary time which has a relationship with the key generation or synchronizing with the video data reception apparatus 200 using a counter value. Here, the master key, the master encryption key, and the key generation-related data are stored in a storage space which is physically safe when a camera is manufactured or the camera is initially registered, and the same values are stored in the first video data reception apparatus 210 which is usually connected to the corresponding camera.

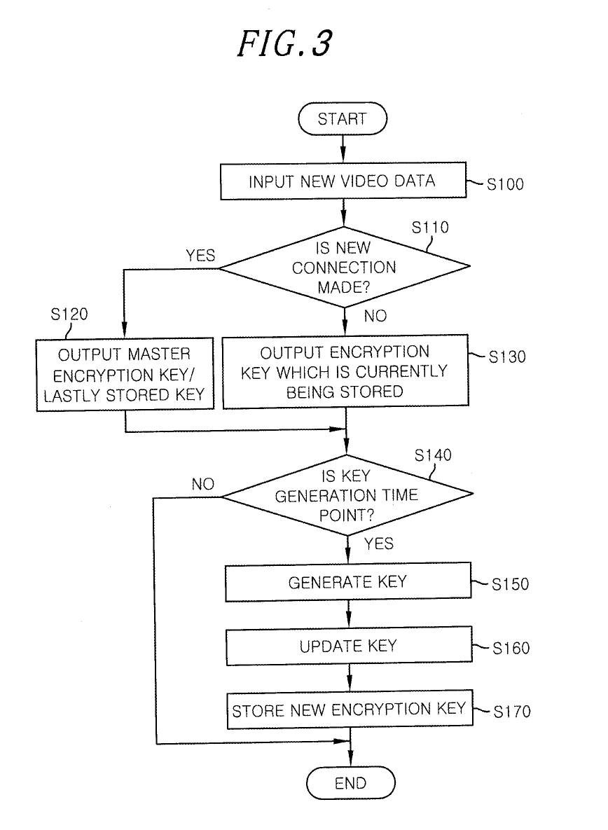

FIG. 3 is a flow chart illustrating a method of generating and updating a key using the camera in accordance with the embodiment of the present invention.

First, when new video data is input to the key management unit 140 from the video processing unit 120, the key management unit 140 starts to operate. The input of new video data is checked in step S100, and the camera 100 determines whether a current time point corresponds to a situation where new connection to the first video data reception apparatus 210 is made in step S110.

When the current time points is a start time point and corresponds to initial connection, the camera outputs a master encryption key from the key data storage unit 144 to the video data encryption unit 130. In the case of reconnection, the camera outputs a key, which was lastly stored at the previous connection and has the same value as the first video data reception apparatus 210, from the key data storage unit 144 to the video data encryption unit 130, thereby performing encryption for current video data in step S120.

When the current time point does not correspond to a start time point, the camera outputs the encryption key which is currently stored in the key data storage unit 144 to the video data encryption unit 130 in step S130.

When the desired key is transmitted to the video data encryption unit 130, the key management unit 140 first determines whether the current time point corresponds to a scheduled key generation time point using key generation-related information stored in the key data storage unit 144 in order to generate and update an encryption key using video data that is currently received in step S140.

When the current time point does not correspond to the key generation time point, the process of generating and updating a key using the video data that is currently received is terminated. When the current time point corresponds to the key generation time point, the key generation unit 142 generates a new key using the received video data by performing a hash function using a master key in step S150.

Thereafter, the generated key is updated by the key update unit 143 in such a way as to apply a data combination method, such as an exclusive OR operation, to an encryption key that is currently being used in step S160.

The generated and updated encryption key is stored in the key data storage unit 144 as a new encryption key so that it can be used to encrypt subsequently input video data in step S170.

If the above-described process is completed, the process of generating and updating video data which is currently received is terminated. Thereafter, when new video data is received, the above-described process is performed from the beginning.

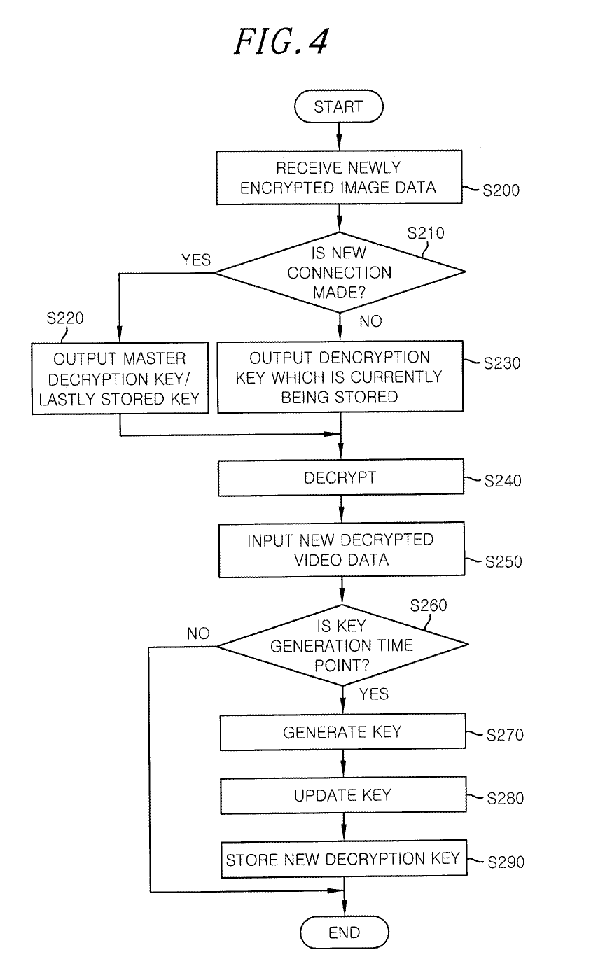

FIG. 4 is a flow chart illustrating a method of generating and updating a key using a first video data reception apparatus in accordance with an embodiment of the present invention.

First, when newly encrypted video data is received from the camera 100 in step S200, it is determined whether a current time point corresponds to a situation in which a new connection to the camera 100 starts in step S210.

When the current time points is a start time point and corresponds to initial connection, a master decryption key which has the same value as the master encryption key of the camera 100 is output to an video data decryption function module. In the case of reconnection, a key, which was stored in previous connection and has the same value as the key value stored in the camera 100, is output to the video data decryption function module, thereby decrypting current video data in step S220.

When the current time points is not a start time point, a decryption key which is currently being stored is output to the video data decryption function module in step S230.

When the key which is necessary for the video data decryption is transmitted, the video data is decrypted in step S240, and decrypted video data which is the same as the original video data is output to a key management function module. Here, the decrypted video data is decoded and then transmitted to an video processing function module in order to restore the video data into video information which can be displayed in step S250.

In order to generate and update a decryption key using the decrypted video data that is currently being received according to the same procedure of generating an encryption key by the camera, the key management function module determines whether the current time point corresponds to a scheduled key generation time point using the key generation-related information corresponding to the connected camera 100 in step S260.

When the current time points is not a key generation time point, the process of generating and updating a key using the video data that is currently being received is terminated. In the case of the key generation time point, a new key is generated using video data received by performing a hash function using a master key corresponding to the connected camera 100 in step S270.

Thereafter, the generated new key is updated by applying a data combination method, such as an exclusive OR operation, to the decryption key which is currently being used in step S280.

The generated and updated decryption key is stored as a new decryption key such that the decryption key can be used to decrypt video data which will be received from the camera 100 in step S290.

When the above-described process has completed, the process of generating and updating a key relevant to the video data which is currently being received is terminated. When new video data is received from the camera, the above-described process is performed from the start.

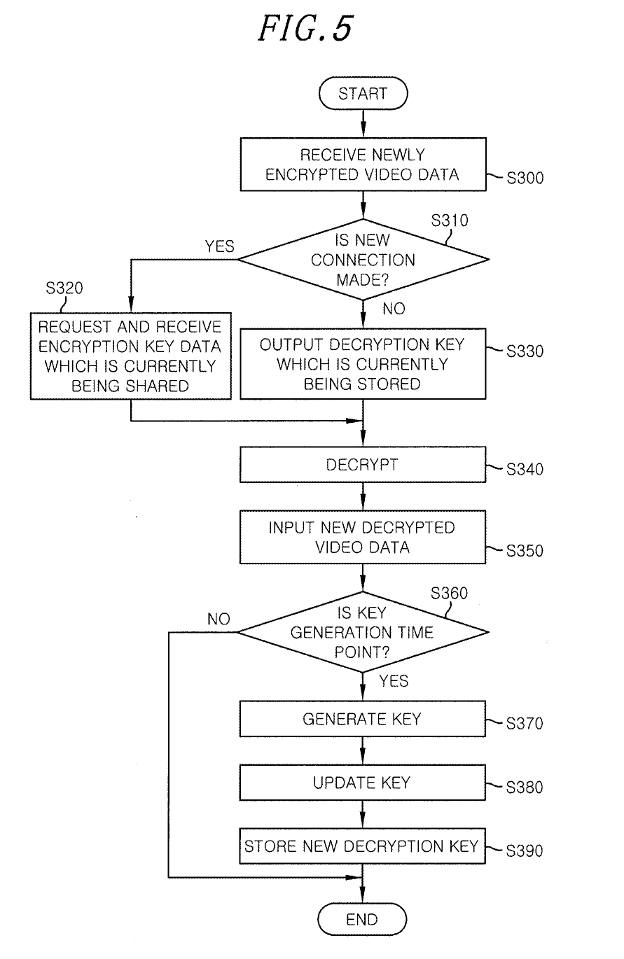

FIG. 5 is a flow chart illustrating a method of generating and updating a key using a second video data reception apparatus in accordance with an embodiment of the present invention.

When the method of generating and updating a key shown in FIG. 5 is compared to the method of generating and updating a key described with reference to FIG. 4, the methods are the same except for steps S220 and S320. Although the first video data reception apparatus 210 is usually connected to the camera 100, the second video data reception apparatus 220 connects the camera 100 only at a necessary time point. Therefore, the second video data reception apparatus 220 cannot perform an initial key synchronization by sharing the master key with the camera 100. Therefore, the second video data reception apparatus 220 determines whether a current time point corresponds to a situation where a new connection to the camera 100 starts in step S310. In the case of the start time point, the second video data reception apparatus requests and receive a key and key-related data which are currently being shared and used between the camera 100 and the first video data reception apparatus 210 from the first video data reception apparatus 210, thereby obtaining a key corresponding to the start time point in step S320. That is, at this time point, the camera 100, the first video data reception apparatus 210, and the second video data reception apparatus 220 may share the same key.

While the invention has been shown and described with respect to the embodiments, it will be understood by those skilled in the art that various changes and modifications may be made without departing from the spirit and scope of the invention as defined in the following claims.

What is claimed is:

1. A security video transmission apparatus for generating and updating an encryption key by using video data, having a property of a random number which is continuously generated in real time, as random number data in order to generate a key, encrypting the video data using the encryption key, and then transmitting the encrypted video data.

2. A security video transmission apparatus, comprising:
an video collection unit for collecting videos and turning the collected videos into information;
an video processing unit for encoding the collected videos, and generating compressed video data which may be easily transmitted;
a key management unit for generating an encryption key by using the video data, having a property of a random number which is continuously generated in real time, as random number data used to generate the key;
an video data encryption unit for encrypting the video data using the encryption key; and
an video data transmission unit for transmitting the encrypted video data to a network.

3. The security video transmission apparatus of claim 2, wherein the key management unit comprises:
an video data input unit for receiving the video data as random number data used to generate a key;
a key generation unit for generating a key having a specific length using the random number data at a previously scheduled key generation time point;
a key update unit for generating a new encryption key by combining the generated key having the specific length with a previous encryption key; and
a key data storage unit for storing key generation-related information including the encryption key.

4. The security video transmission apparatus of claim 1, wherein the security video transmission apparatus verifies integrity by sharing a same encryption key with an video data reception apparatus which receives the video data in order to store, check and monitor the video data, and by performing encryption and decryption using the encryption key.

5. The security video transmission apparatus of claim 3, wherein the key generation-related information is physically stored in a storage space when the security video transmission apparatus is manufactured or when the security video transmission apparatus is initially registered, and the key generation-related information is stored in an video data reception apparatus which is usually connected to the security video transmission apparatus.

6. An encryption key generation method using a security video transmission apparatus, comprising:
generating an encryption key by using video data, having a property of a random number which is continuously generated in real time, as random number data used to generate a key; and
updating the generated the encryption key to a new encryption key by combining the generated encryption key with a previous encryption key.

7. The encryption key generation method of claim 6, wherein the generating comprises:
receiving the video data and starting a key generation function;
checking whether a new connection to an video data reception apparatus for receiving the video data has been made;
when the new connection has been made, outputting a previously stored master encryption key or a key which was lastly stored in previous connection as the encryption key; and
when the new connection has not been made, outputting an encryption key that is currently being stored.

8. The encryption key generation method of claim 7, wherein the generating comprises:
outputting the encryption key, and then checking whether a current time point corresponds to a key generation time point which was scheduled with the video data reception apparatus; and
when the current time point corresponds to the key generation time point, generating a new key using a master key based on the received video data.

9. A decryption key generation method using an video data reception apparatus, comprising receiving video data while usually accessing a security video transmission apparatus; and generating and updating a decryption key, which is identical to an encryption key of the security video transmission apparatus, using original video data obtained by decrypting the received and encrypted video data, thereby sharing a key with the security video transmission apparatus without performing a separate key transmission process.

10. The decryption key generation method of claim 9, further comprising:
receiving a new encrypted video data from the security video transmission apparatus;
checking whether a new connection to the security video transmission apparatus has been made;
when the new connection has been made, outputting a stored master decryption key or a key, which was lastly stored in a previous connection, as a decryption key; and
when the new connection has not been made, outputting a decryption key that is currently being stored.

11. The decryption key generation method of claim 9, further comprising:
receiving new encrypted video data from the security video transmission apparatus;
checking whether a new connection to the security video transmission apparatus has been made,
when the new connection has been made, requesting and receiving a key, shared and used with the security video transmission apparatus through a previously defined arbitrary procedure, from an video data storage apparatus which is usually connected to the security video transmission apparatus, and then outputting the key as a decryption key;
when the new connection has not been made, outputting a decryption key which is currently being stored.

12. The decryption key generation method of claim 10, further comprising:
receiving new decrypted video data and starting a key generation function;
checking whether a current time point corresponds to a key generation time point scheduled with the security video transmission apparatus;
when the current time point corresponds to the key generation time point, generating a new key using a master key based on the received video data.
